(19) United States
(12) Patent Application Publication
(10) Pub. No.: US 2008/0271119 A1
(43) Pub. Date: Oct. 30, 2008

(54) BEHAVIORAL ADVERTISING AND CREATION OF AD-HOC MICROCOMMUNITIES THROUGH USER AUTHENTICATION

(75) Inventors: Ramesh Manne, Redmond, WA (US); George M. Moore, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 12/016,959

(22) Filed: Jan. 18, 2008

Related U.S. Application Data
(63) Continuation of application No. 11/741,667, filed on Apr. 27, 2007.

(51) Int. Cl. G06F 7/04; G06Q 30/00; H04L 9/32

(52) U.S. Cl. 726/3; 705/14; 705/10

(57) ABSTRACT

Implementations of behavioral advertisement targeting and creation of ad-hoc microcommunities through user authentication are described. In one implementation, a user is allowed to submit authentication information on a webpage associated with a third party website. For example, a user can identify himself by entering a username and password to an email account unaffiliated with the third party website. The authentication information can then be used to access a personal account associated with the user. For example, behavioral data associated with the user can be gathered from the personal account and be used to present advertisements on the webpage targeting a specific behavioral profile of the user. Alternately, the user can be presented with options to interact with information in the personal account. For example, the user may be given the opportunity to invite members of a contacts list in the personal account to visit the webpage.

### RELATED APPLICATIONS

Portions of the current application are a continuation of, and claim priority from, the coassigned and copending U.S. patent application Ser. No. 11/741,667 filed on Apr. 27, 2007, and entitled “Behavioral Advertising and Creation of Ad-hoc Microcommunities Through User Authentication”.

### BACKGROUND

Hosting advertisements can be a lucrative business for website owners, especially when the advertisements are specifically targeted to visitors viewing a webpage. For example, advertisements for golfing equipment can be presented on a news webpage when a visitor with an established propensity for buying golfing equipment visits the page. Similarly, the same webpage can feature home ownership products and services, such as loans and realty services, when another visitor with an established interest in real estate visits the page. In some instances, targeted advertisements can fetch a 1000% price premium over non targeted advertisements.

Websites can currently target advertisements to visitors through the use of information gleaned from cookies placed on visitors' computers. The utility of cookies is limited, however, since cookies only provide a record of a visitor's past interactions with a particular website, and many visitors routinely clear cookies on their machines. Also, many visitors refuse to allow the placement of cookies on their machines in the first place.

In addition to specifically targeting advertisements to visitors of a webpage, website owners can also increase website advertising revenues by attracting additional visitors to a website. In this way, advertisements on the website can be presented to a wider audience of potential customers.

### SUMMARY

Implementations of behavioral advertisement targeting and creation of ad-hoc microcommunities through user authentication are described. In one implementation, a user is allowed to submit authentication information on a webpage associated with a third party website. For example, a user can identify himself by entering a username and password to an email account unaffiliated with the third party website. The authentication information can then be used to access a personal account associated with the user. For example, behavioral data associated with the user can be gathered from the personal account and be used to present advertisements on the webpage targeting a specific behavioral profile of the user.

Alternately, the user can be presented with options to interact with information in the personal account. For example, the user may be given the opportunity to invite members of a contacts list in the personal account to visit the webpage. In another possible implementation, the user may be given the opportunity to load files to and/or from the personal account to the webpage.

This summary is provided to introduce a selection of concepts that are further described below in the detailed description. This summary is not intended to identify key features or essential features of the claimed subject matter, nor is it intended to be used as an aid in determining the scope of the claimed subject matter.

### BRIEF DESCRIPTION OF THE CONTENTS

The detailed description is described with reference to the accompanying figures. In the figures, the left-most digit of a reference number identifies the figure in which the reference number first appears. The use of the same reference numbers in different figures indicates similar or identical items.

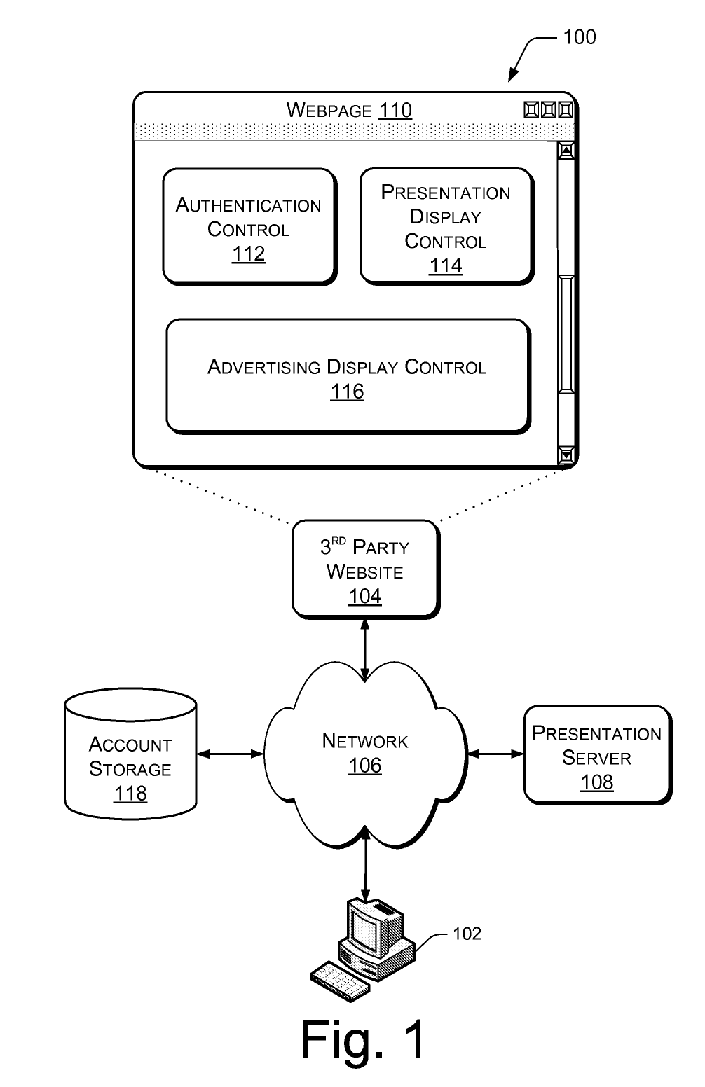

FIG. 1 illustrates an exemplary environment in which behavioral advertisement targeting and creation of ad-hoc microcommunities through user authentication may be implemented.

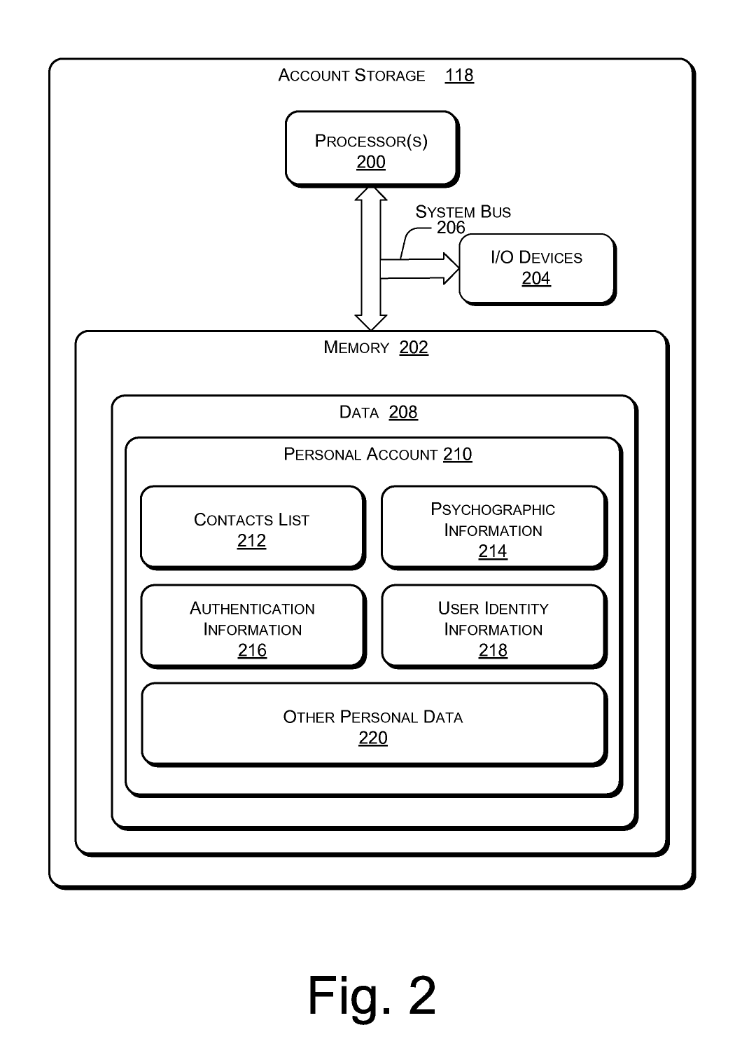

FIG. 2 illustrates an exemplary presentation server.

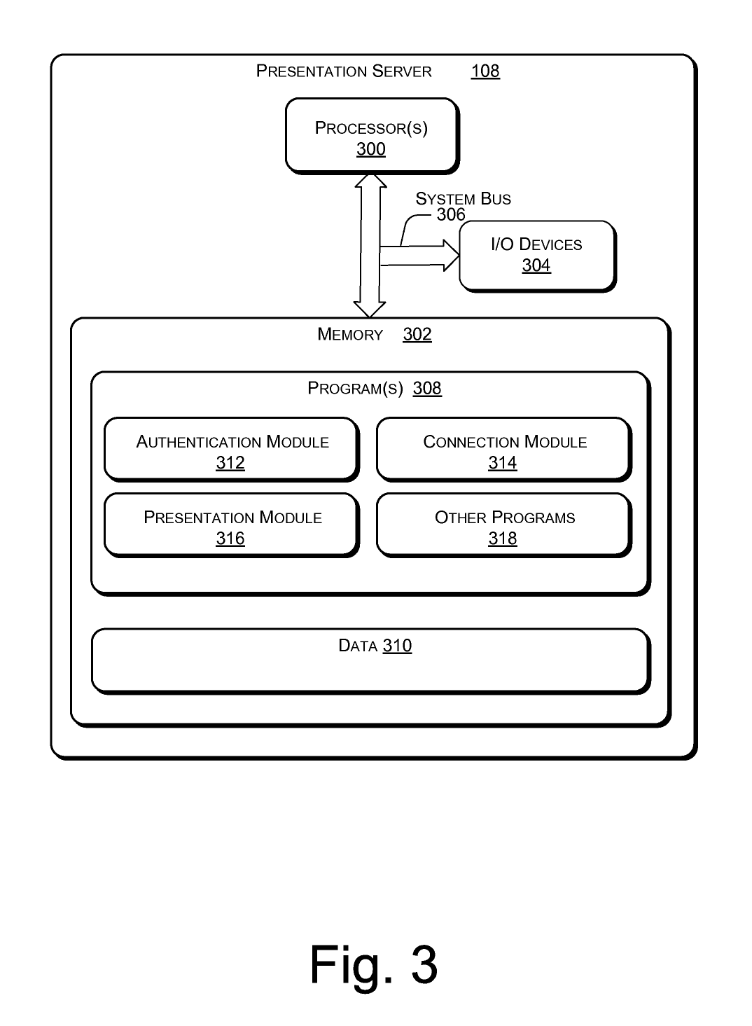

FIG. 3 illustrates an exemplary account storage.

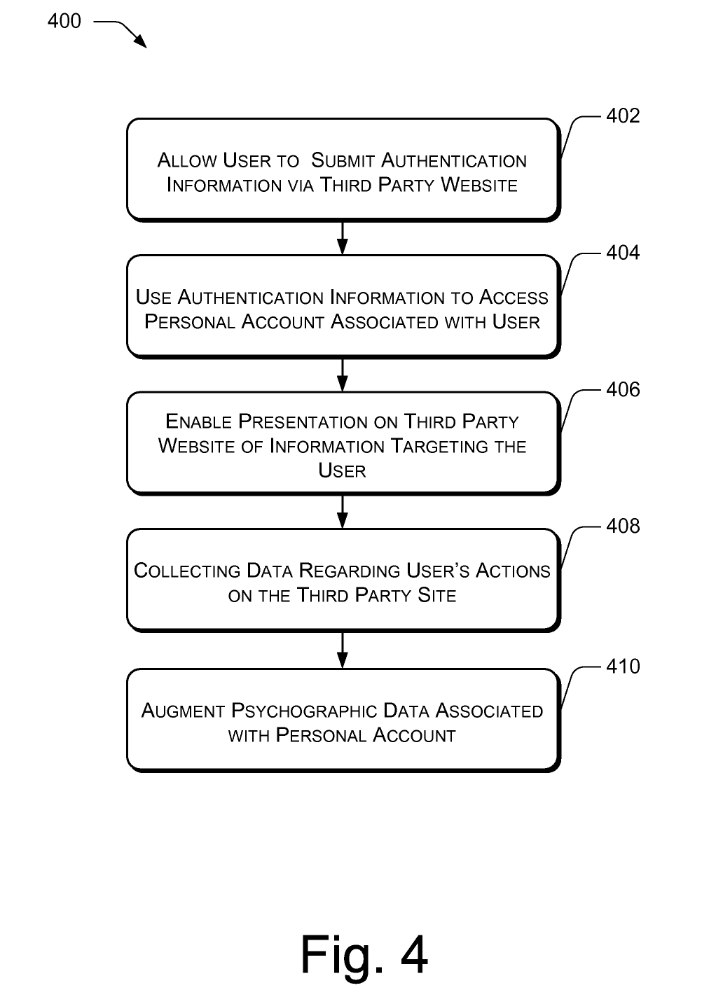

FIG. 4 illustrates an exemplary process for behavioral advertisement targeting and creation of ad-hoc microcommunities through user authentication on a third party website.

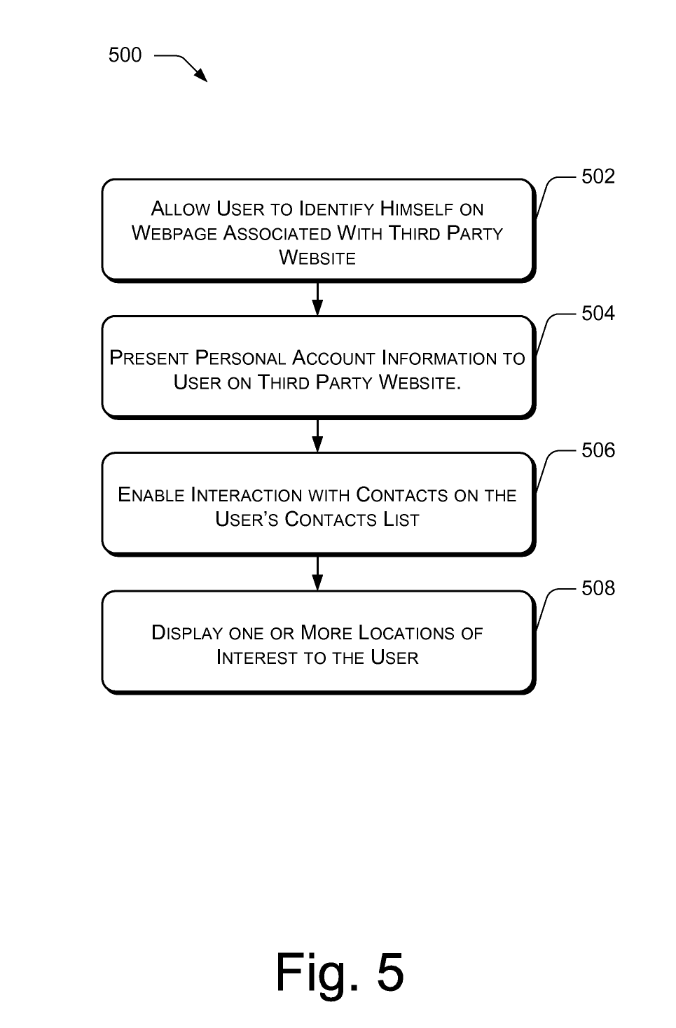

FIG. 5 illustrates an exemplary process for creation of ad-hoc microcommunities through user authentication on a third party website.

### DETAILED DESCRIPTION

This disclosure is directed to apparatus and techniques for implementing behavioral advertisement targeting and creation of ad-hoc microcommunities through user authentication. More particularly, the apparatus and techniques described herein involve allowing a user to enter authentication information associated with an existing personal account onto a webpage associated with a third party website. Data associated with the personal account can then be accessed and used to present information targeted to the user on the webpage.

For example, advertisements targeted to behavioral traits of the user suggested in the data associated with the personal account may be presented to the user on the webpage. Similarly, the user may be given the option of interacting with data in the personal account. For instance, the user may be allowed to access a contacts list in the personal account and send information from the webpage to selected entries in the contacts list. Moreover, the user may be allowed to access files in the personal account, such as image files, and download files to and from the webpage.

### Exemplary Environment

FIG. 1 shows an exemplary environment 100 suitable for implementing behavioral advertisement targeting and creation of ad-hoc microcommunities through user authentication. Environment 100 includes an access device 102 configured to access a third party website 104 via a network 106. Access device 102 can include a variety of computing-based devices including, for example, a server, a game console, a desktop PC, a notebook or portable computer, a workstation, a mainframe computer, an Internet appliance, a mobile phone, and so on.

Similarly, network 106 can include a variety of devices configured to allow access device 102 to gain access to websites, such as third party website 104. Network 106 can include a wireline and/or wireless network, or any other electronic coupling means, including the Internet. In one possible implementation, access device 102 is coupled to network 106 though a network server. In such an implementation, the network server can include any computing-based device configured to facilitate communication between access device 102 and network 106. For example, the network server can include a dedicated server, a desktop PC, a notebook or portable computer, a workstation, a mainframe computer, and so on.

Environment 100 also includes a presentation server 108 configured to allow a user interacting with access device 102 to identify himself while viewing a webpage 110 associated with third party website 104. Presentation server 108 can include a variety of computing-based devices, including a dedicated server, a desktop PC, a notebook or portable computer, a workstation, a mainframe computer, and so on. Furthermore, presentation server 108 can be coupled to network 106 through a wireline coupling, a wireless coupling, or any other coupling known in the art. The makeup and function of presentation server 108 will be discussed in more detail in conjunction with FIG. 3 below.

Using access device 102, a user can access various media content on webpage 110, including graphic content, audio content and video content. Webpage 110 can include public and private pages viewed over the Internet, such as news sites, networking sites, company webpages, and so on.

Webpage 110 can also include an authentication control 112, and one or more display controls, such as a presentation display control 114 and an advertising display control 116. In one example implementation, a user viewing webpage 110 can be presented with an opportunity to identify himself by entering authorization information for a personal account associated with the user into authentication control 112. Personal accounts can include any accounts associated with the user, such as email accounts, instant messaging accounts, online purchasing accounts, etc.

Authentication control 112 can be a fixed portion of webpage 110 with fields in which a user can enter identity information such as an anonymous ID (ANID), a username, password, and so on. Alternately, authentication control 112 can be a pop up window presented to a user viewing webpage 110.

In one implementation, authentication control 112 can be controlled by presentation server 108, with third party website 104 and webpage 110 having no control over, or access to, information presented in, or entered into, authentication control 112. Moreover, it will be understood that the terms “identity” and “authentication information” can be used interchangeably to mean any information that can be submitted by a user to identify the user.

Once the user's identity has been submitted via webpage 110, presentation server 108 can use the identity to access a personal account associated with the user stored on an account storage 118. Account storage 118 can include a variety of information associated with personal accounts, including authentication information, personal information entered by users, and previous actions of users associated with the personal accounts. Account storage 118 can include any device on which computer readable data and/or instructions may be stored. For example, account storage 118 can include a variety of computing-based devices including, for example, a server, a workstation, a mainframe computer, and so on. Account storage 118 can be coupled to network 106 through a wireline coupling, a wireless coupling, or any other coupling known in the art. Moreover, account storage 118 can be coupled directly to presentation server 108. The makeup and function of account storage 118, including the types of information associated with personal accounts that can be stored on account storage 118, will be discussed in more detail in conjunction with FIG. 2 below.

Once the user's personal account on account storage 118 has been accessed, presentation server 108 can use data from the user's personal account to display targeted information to the user on webpage 110 in one or more display controls. For example, presentation server 108 can use data from the user's personal account to display targeted information to the user on webpage 110 in presentation display control 114. Presentation display control 114 can include a portion of webpage 110 under the control of presentation server 108. In one implementation, third party website 104 has no control over, or access to, information presented in presentation display control 114.

In another possible implementation, targeted information can be displayed to the user on webpage 110 in advertising display control 116. Advertising display control 116 can include a portion of webpage 110 dedicated to the presentation of advertisements, such as banner advertisements, to the user on webpage 110. Advertising display control 116 can be under the control of an advertising agency having an agreement to target advertisements to visitors of webpage 110. In this and other implementations, third party website 104 may have no control over, or access to, information presented in advertising display control 116.

The targeted information presented to the user on webpage 110 can create a customized experience for the user, making webpage 110 more comfortable and inviting. This can increase the user's dwell time on webpage 110 and encourage repeat visits to webpage 110. Also, as will discussed in more detail below, by allowing the user to submit their identity via webpage 110, the personal account associated with the user stored on account storage 118 can be used to attract additional traffic to webpage 110.

In one implementation, advertisements targeting behavioral traits of the user can be presented to the user in display controls, such as presentation display control 114 and/or advertising display control 116. Such advertisements can be interactive, so that a click initiated by the user on the advertisement can lead the user to more information concerning the advertisement. For example, upon selecting an advertisement on webpage 110, a new instance of a browser can be opened and a new webpage associated with the advertisement can be displayed in the browser. Alternately, a webpage associated with the advertisement can be loaded into an open web browser being used by the user, for example, replacing webpage 110.

Additionally, once the user's personal account on account storage 118 has been accessed, presentation server 108 can offer the user one or more opportunities to interact with data in the personal account via various presentations in presentation display control 114. For example, the user may choose to interact with a contacts list in his personal account. Examples of contact lists include address books, buddy lists, etc.

In one implementation, the contacts list can be displayed in presentation display control 114 along with various information associated with the contacts list, including presence information of entities in the contacts list, and markers denoting various activities of the entities. One such marker can include a marker indicating that a given entity in the contacts list has updated information associated with itself. For example, the marker can indicate that the entity has updated a weblog with which it is associated, or the marker can indicate that the entity has made public new information, such as image files, on a website with which it is associated.

In this way the user can view the status of all entities in his contacts list, and view and/or interact with other information in his personal account. In one possible implementation, the user can view his contacts list in presentation display control 114 and invite selected entities in his contacts list to visit webpage 110. Alternately, in another possible implementation, the user can interact with the contacts list presented in presentation display control 114 and send content to selected entities in his contacts list by simply selecting the entities and choosing one of several available activities, such as sending a link to the content, or sending the content in an email. Moreover, as will be discussed in more detail below, the user's whereabouts on and/or interactions with webpage 110 can be made available to contacts in the user's contacts list.

In these ways, the user's presence on webpage 110 can be used to drive other users (such as contacts from the user's contacts list) to webpage 110 as well as to webpages associated with information presented in display controls, such as presentation display control 114, and advertising display control 116 on webpage 110. This can lower the traffic acquisition costs (TAC) of webpage 110 in attracting users. It can also lower the TAC of other webpages associated with information presented in display controls on webpage 110.

Once the personal account of the user on webpage 110 has been accessed, the user can be allowed to interact with data in the personal account, and exchange data between the account and webpage 110. In one implementation, the types of interactions with data in the personal account which can be offered to the user in presentation display control 114 can be pre-programmed into presentation server 108. In another implementation, the types of interactions between the user and the personal account can depend on various factors, such as the type of personal account associated with the user, and a relationship between website 104 with an entity administering or hosting the personal account.

It will be understood that third party website 104 can include any website not being directly controlled by the user, or an entity administering or hosting the personal account of the user. For example, third party website 104 can include a news website unaffiliated with the user or an email account used by the user. Similarly, third party website 104 can include an entertainment site, such as a site selling MP3 files, not under the control of either the user or an entity administering an instant messaging account associated with the user.

### Exemplary Account Storage

FIG. 2 illustrates various components of account storage 118 according to one embodiment of behavioral advertisement targeting and creation of ad-hoc microcommunities through user authentication. Account storage 118 can include one or more processor(s) 200, a memory 202, input/output (I/O) devices 204 (e.g., keyboard, display, and mouse), and a system bus 206 operatively coupling the various components of account storage 118.

System bus 206 represents any of several types of bus structures, including a memory bus or memory controller, a peripheral bus, an accelerated graphics port, and a processor bus or local bus using any of a variety of bus architectures. By way of example, such architectures can include an industry standard architecture (ISA) bus, a micro channel architecture (MCA) bus, an enhanced ISA (EISA) bus, a video electronics standards association (VESA) local bus, a peripheral component interconnects (PCI) bus also known as a mezzanine bus, a PCI express bus, a universal serial bus (USB), a secure digital (SD) bus, and an IEEE 1394 (i.e., FireWire) bus.

Memory 202 can include computer-readable media in the form of volatile memory, such as RAM and/or non-volatile memory, such as ROM, or flash RAM. Memory 202 can also include data and program modules for implementing behavioral advertisement targeting and creation of ad-hoc microcommunities through user authentication which are immediately accessible to, and presently operated on, by processor(s) 200.

Memory 202 can further include data 208. Data 208 can include one or more personal accounts 210, with each personal account 210 including information such as a contacts list 212, psychographic information 214, authentication information 216, user identity information 218, and various other user data 220 associated with personal account 210.

Though account storage 118 is depicted as a single device, it will be understood that account storage 118 can include several devices. For example, the elements on account storage 118 may exist across several devices. Additionally, elements on account storage 118 may exist on different devices at different times. Furthermore, programs on account storage 118 may be implemented in software, firmware, or any other computer readable instructions known in the art.

In one implementation, personal account 210 can include any account which may be associated with a user. This can include an email account, an instant messaging account, an account used to make online purchases, an account configured to enable a user to view certain content, etc. Contacts list 212 can include information regarding contacts such as friends, colleagues, and other individuals and entities with which the user associated with personal account 210 may interact. Information stored in contacts list 212 can include information such as contact identities, as well as contact phone numbers, contact email addresses and so on.

Personal account 210 can also include psychographic information 214 regarding past behavior of the user. This information can include raw data regarding sites visited by the user, searches conducted by the user, articles read by the user, duration of stays at the sites (aka dwell times), buying histories of the user, download histories of the user, interactions with contacts from contacts list 212, and any other information collected concerning the user's habits while the user was signed in or otherwise interacting with personal account 210. This information can include information gleaned from cookies which were placed on access device 102 while the user was interacting with one or more websites associated with an entity administering personal account 210.

Psychographic information 214 can also include information gleaned from processing raw data associated with the user's behavior while the user was signed in or otherwise interacting with personal account 210. This can include behavioral traits of the user, and as well as profiles of the user gleaned from the raw data.

Though FIG. 2. illustrates psychographic information 214 as residing in personal account 210 on account storage 118, it will also be understood that psychographic information 214 can reside on other devices. For example, psychographic information 214 could reside on one or more servers, such as presentation server 108.

Authentication information 216 can include any information used by a user to establish his association with personal account 210. For example, authentication information 216 can include usernames, passwords, etc.

User identity information 218 can include information associated with a user's identity. In one implementation, user identity information 218 can be entered by the user or another entity, and/or user identity information 218 can be automatically generated. For example, when creating or updating personal account, the user can enter information such as his name, address, marital status, hobbies, interests contact information (such as phone number and email address), age, profession, sex, religion, race, etc., into personal account 210. Though pictured in FIG. 2 as being separate from psychographic information 214, it will be understood that user identity information 218 may also be a part of psychographic information 214.

Other personal data 220 can include any other data saved in the personal account 210. For example, other personal data 220 may include files, such as image files, text files, website bookmarks, calendars, to do lists, and so on saved in personal account 210.

### Exemplary Presentation Server

FIG. 3 illustrates various components of presentation server 108 according to one embodiment of behavioral advertisement targeting and creation of ad-hoc microcommunities through user authentication. Presentation server 108 can include one or more processor(s) 300, a memory 302, input/output (I/O) devices 304 (e.g., keyboard, display, and mouse), and a system bus 306 operatively coupling the various components of presentation server 108.

System bus 306 represents any of several types of bus structures, including a memory bus or memory controller, a peripheral bus, an accelerated graphics port, and a processor bus or local bus using any of a variety of bus architectures. By way of example, such architectures can include an industry standard architecture (ISA) bus, a micro channel architecture (MCA) bus, an enhanced ISA (EISA) bus, a video electronics standards association (VESA) local bus, a peripheral component interconnects (PCI) bus also known as a mezzanine bus, a PCI express bus, a universal serial bus (USB), a secure digital (SD) bus, and an IEEE 1394 (i.e., FireWire) bus.

Memory 302 can include computer-readable media in the form of volatile memory, such as RAM and/or non-volatile memory, such as ROM, or flash RAM. Memory 302 can also include data and program modules for implementing behavioral advertisement targeting and creation of ad-hoc microcommunities through user authentication which are immediately accessible to, and presently operated on, by processor(s) 300.

Memory 302 can include programs 308 and data 310. Programs 308 can include an authentication module 312, a connection module 314, a presentation module 316 and other programs 318. Data 310 can include any data which might be useful in implementing behavioral advertisement targeting and creation of ad-hoc microcommunities through user authentication, including policies to be used with specific websites, and other data.

Though presentation server 108 is depicted as a single device, it will be understood that presentation server 108 can also include several devices. For example, the elements on presentation server 108 may exist on several devices. Additionally, elements on presentation server 108 may exist on different devices at different times. Furthermore, programs 308 on presentation server 108 may be implemented in software, firmware, any other computer readable instructions known in the art, or any combination thereof.

In one implementation, connection module 314 can couple presentation server 108 to webpage 110 via network 106 and website 104. Connection module 314 can include addresses of one or more webpages, such as webpage 110, on which presentation server 108 can display information in one or more authentication controls 112 and one or more display controls, such as presentation display control 114 and advertising display control 116.

Once a coupling with webpage 110 is established, presentation module 316 can transmit information to be presented in the one or more authentication controls 112 and display controls. For example, before a user accessing webpage 110 has identified himself, presentation module 316 can present an invitation to the user to identify himself in authentication control 112. This invitation can include text, graphics, and media content—including audio and video presentations.

The invitation can also include information regarding benefits accruing to the user if the user identifies himself. For example, presentation module 316 can encourage the user to sign into personal account 210, such as an email account associated with the user, so that the user can quickly email content on webpage 110 to one or more contacts in contacts list 212. Similarly, presentation module 316 can encourage the user to sign into a web account associated with the user so that the user can load files to and from the web account, such as image, audio and/or video files, to webpage 110.

In another possible implementation, presentation module 316 can invite the user to sign into personal account 210 associated with the user so that the user can invite contacts to visit webpage 110, or simply announce to contacts that the user is on webpage 110.

Presentation module 316 can maintain various user interaction tools in authentication control 112 enabling the user to input their identity. In one implementation, presentation module 316 can present one or more fields in authentication control 112 in which the user can enter authorization information such as usernames, passwords, and so on corresponding to one or more personal accounts associated with the user.

Once the user has entered the authorization information, authenticating module 312 can use the authorization information to access the user's personal account 210. Once personal account 210 is accessed, various information associated with personal account 210 can be accessed. This includes information entered into personal account 210 by the user, as well as information associated with user interactions with various websites, webpages, and other entities while the user was signed into personal account 210, or while the user was otherwise using personal account 210. The information in the personal account can be used to present information targeted to the user on webpage 110. Information targeted to the user can be presented in the display controls and/or authentication control 112 by presentation module 316.

### Behavioral Advertisement Targeting

In one implementation, presentation server 108 can present targeted information to the user in the form of advertisements based on information in personal account 210. For instance, presentation module 316 can access psychographic information 214 associated with the user from personal account 210. This information can be used to target advertisements to the user on webpage 110.

For example, if psychographic information 214 in personal account 210 indicates that the user has frequented sites devoted to mixed martial arts, presentation module 316 can display an advertisement in presentation display control 114 and/or advertising display control 116 on webpage 110 advertising boxing gloves and other equipment used in mixed martial arts training. Similarly, if psychographic information 214 in personal account 210 indicates frequent visits to and/or interactions with sites associated with a particular athletic team, presentation module 316 can display an advertisement for an online store specializing in apparel for the given athletic team in presentation display control 114 and/or advertising display control 116.

### Creation of Ad-Hoc Microcommunities

In another possible implementation, presentation server 108 can present targeted information to the user based on information in personal account 210 such that one or more microcommunities can be formed. For example, as mentioned above, information from personal account 210, such as contacts list 212, user identity information 218 and other personal data 220, may be presented to the user in presentation display control 114. In this way the user may interact with information in personal account 210 through presentation display control 114. It will also be understood that information from personal account 210 may additionally be presented to the user in a similar manner in authentication control 112.

In one implementation, information regarding points associated with personal account 210 can be presented to the user in presentation display control 114 and/or authentication control 112. For example points earned or purchased from an entity administering personal account 210 can be accessed by the user through presentation display control 114 and/or authentication control 112. Moreover, the points can be used to barter with other users, or purchase goods and services from webpage 110 and/or websites to which the user has traveled after interacting with advertisements presented to the user on webpage 110.

In another possible implementation, contacts list 212 from an email account or instant messaging account can be presented to the user in authentication control 112 and/or presentation display control 114. In addition to names of contacts, any other information available regarding the contacts, including various web controls, can be displayed. For example, presence information indicating whether the contact is signed on or not, as well as activity information indicating what the contact is doing (for example, listening to music, visiting a website, etc.) can be displayed.

In one exemplary implementation, the activity information can include detailed information, such as artists and titles of songs being listened to by contacts. Similarly, the activity information can include the addresses of websites being viewed by contacts, as well as information regarding content on the particular webpage being viewed, such as titles of articles on the webpage, and authors of content on the webpage.

Activity information can also include indicators such as gleams, which report recent amendments or inputs of information associated with a contact. For instance, a gleam positioned by a contact's name in a contacts list can indicate that address information associated with the contact has changed. Similarly, a gleam can indicate that a blog or other website with which the contact is associated has been updated.

In one exemplary implementation, the user can invite contacts on contact list 212 to join him in viewing webpage 110. For example, the user can be automatically prompted in authentication control 112 and/or presentation display control 114 to select contacts to which the user would like to communicate an invitation. The invitation can be sent, for example by presentation server 108, in the form or an email or instant message to the selected contacts inviting the contacts to view webpage 110. Alternately, contacts on contacts list 212 can be presented with the address for webpage 110 as a link next to the identity of the user on their respective contacts lists.

If contacts on contacts list 212 decide to accept the invitation, they can access webpage 110 and interact with the user, and with each other, in various ways. For example, a field for instant messaging can be presented in authentication control 112 and/or presentation display control 114 allowing to the contacts and the user to communicate via instant messages. Similarly, the contacts and the user may be allowed to leave comments on the webpage which can be read in authentication control 112 and/or presentation display control 114. In another possible implementation, instant messages and comments may be placed on other areas of webpage 110 outside of authentication control 112 and presentation display control 114.

The user and the contacts can also share other information, such as text files, images files, video files, by posting invitations to access the information on webpage 110 (such as in authentication control 112 and presentation display control 114). In one implementation, if the user or one of the contacts decides to accept a file being offered for sharing, the file can be retrieved from the personal account 210 corresponding to the offeror and be transmitted to the personal account 210 of the recipient. In one exemplary implementation, the file can be retrieved and transmitted by presentation module 316.

In yet another possible implementation, the user and his contacts can participate in website hopping. For example, by viewing presence information associated with contacts list 212, the user can see where his contacts are on webpage 110 (as well as other webpages). If desirable, the user can access a webpage being viewed by one or more of his contacts. Moreover, the user can begin interacting with his contacts on the webpage through blogging or instant messaging as described above. In a similar manner, contacts can join the user by looking at presence information associated with the user on their contacts lists. In this way, the user and his contacts can freely navigate from page to page within a website, or across multiple websites.

In another possible implementation, the user may be presented with one or more locations of interest. For example, the user can be provided with a most lively location. This can include a webpage that is currently being visited by more of his contacts than any other webpage. Alternately, the user can be provided with other locations of interest, such as webpages experiencing different types and levels of activity. These can include webpages which have been visited by many of his contacts currently and/or in the past, webpages that have experienced long visit times by his friends currently and/or in the past, and so on.

The one or more locations of interest can be presented to the user in a separate field on webpage 110, such as in authentication control 112 and/or presentation display control 114. Alternately, the one or more location of interest can be indicated by special highlighting in the presence information on contacts lists 212.

The user can also be given the opportunity to choose a level of comfort in interacting with his personal account(s) 210 through use of one or more authorization controls. Authorization controls can include prompts discussing the types of information which may be disclosed to an entity administering presentation server 108, or which information from personal account 210 may be shared with various entities, including contacts in contacts list 212, if the user chooses certain options. Alternately, authorization controls may simply confirm that a user wishes to complete certain actions, such as send information to contacts in contacts lists, etc.

Also, regardless of what kind of information is targeted to the user, be it targeted advertisements, information from the user's personal account 210, or both, once the user has provided his identity to presentation server 108, the interactions of the user with webpage 110 can be monitored and stored. Further the interactions of the user with advertisements or further navigations from webpage 110 can be tracked and stored. This information can then be stored in psychographic information 214, enriching the data stored there regarding behavior of the user.

### Exemplary Methods

FIGS. 4-5 illustrate exemplary methods for implementing aspects of behavioral advertisement targeting and creation of ad-hoc microcommunities through user authentication. The methods are illustrated as a collection of blocks in a logical flow graph representing a sequence of operations that can be implemented in hardware, software, firmware, etc., or any combination thereof. The order in which the methods are described is not intended to be construed as a limitation, and any number of the described method blocks can be combined in any order to implement the methods, or alternate methods. Additionally, individual blocks may be deleted from the methods without departing from the spirit and scope of the subject matter described therein. In the context of software, the blocks can represent computer instructions that, when executed by one or more processors, perform the recited operations. Moreover, for discussion purposes, and not purposes of limitation, selected aspects of the methods may described with reference to elements shown in FIGS. 1-3.

### Exemplary Method I

FIG. 4 illustrates an exemplary method 400 for implementing aspects of behavioral advertisement targeting and creation of ad-hoc microcommunities through user authentication. At block 402, a user visiting a webpage associated with a third party website, such as webpage 110, is allowed to submit authentication information on the webpage. For example, a user visiting a webpage, such as webpage 110, can be presented with prompts or invitations to enter authentication information associated with a user's personal account, such as personal account 210. The authentication information can include usernames, passwords and so on. Additionally, the authentication information can be entered into an authentication control, such as authentication control 112.

At block 404, authentication information submitted at block 402 can be compared to authentication information associated with the user's personal account. If the entered authentication information is correct, it can be used to access the user's personal account. For example, a server, such as presentation server 108, can use the entered authentication information to access the user's personal account.

At block 406, information targeting the user can be presented on the webpage. In one implementation, the information targeting the user can be displayed in a display control, such as presentation display control 114 and/or advertising display control 116, on the webpage.

The information targeting the user can be derived from the information in the user's personal account. For example, psychographic information, such as psychographic information 214, associated with the user's personal account can be used to present targeted advertisements to the user on the third party website. For example, presentation server 108 can access psychographic information 214 associated with the user from personal account 210. This information can be used to target advertisements to the user on webpage 110. In one exemplary implementation, if psychographic information in the user's personal account indicates that the user has frequented sites devoted to mixed martial arts, a presentation module can display an advertisement in a display control on the webpage advertising boxing gloves and other equipment used in mixed martial arts training.

Alternately, the information targeting the user can include offers and/or opportunities for the user to interact with information associated with the user's personal account. For example, the user may be given the option to load files in the personal account to and/or from the webpage. Similarly, the user can be given the option to load contact information for entities presented on the webpage—including an address of the webpage—into the personal account.

In yet another possible implementation, the user can be given the opportunity to interact with a contacts list in the personal account. For example, the user can be given the opportunity to invite contacts on the contacts list to visit the webpage. Additionally, the user may be given the opportunity to email content on the website to one or more contacts on the contacts list. Moreover, the user may be given the option to view any information associated with the contacts list, including presence information, activity information, and update information associated with contacts. For instance, the user may be able to see that a contact is viewing a given article on the webpage, and quickly click a link taking him to the same article. In this and similar manners, one or more microcommunities can be formed.

At block 408, data regarding the user's actions on the third party website can be collected. For example, what links the user follows, what files the user downloads, how long the user visits certain articles on the website, etc., can be monitored and collected. Additionally, actions on other webpages the user views after identifying himself on the third part website can be stored.

At block 410, the information collected at block 408 can be used to augment the psychographic information associated with the user's account. For example, the collected data regarding the user's interactions after the user identifies himself on the third party website can be transmitted by presentation server 110 to account storage 118 and stored in psychographic information 214.

### Exemplary Method II

FIG. 5 illustrates an exemplary method 500 for implementing aspects of creation of ad-hoc microcommunities through user authentication.

At block 502, a user is allowed to identify himself on a webpage associated with a third party website, such as website 104. For example, a user visiting a webpage, such as webpage 110, can be presented with prompts or invitations to enter authentication information associated with a personal account, such as personal account 210. The authentication information can include usernames, passwords and so on. The authentication information can be used to access the user's personal account.

At block 504, information from the user's personal account can be presented to the user via the third party website. In one implementation, the information from the user's personal account can be displayed in a presentation display control, such as presentation display control 114, on a webpage associated with third party website.

At block 506, the user can be given the opportunity to interact with a contacts list in the user's personal account. For instance, the user can be given the opportunity to invite contacts on the contacts list to visit the webpage. Additionally, the user may be given the opportunity to email content on the website to one or more contacts on the contacts list. Moreover, the user may be able to view any information associated with the contacts list, including presence information, activity information, and update information, associated with the contacts.

In one implementation, the user may be able to see that a contact is viewing a given article on the webpage, and quickly click a link taking him to the same article. In yet another possible implementation, the user and his contacts can participate in bar hopping. For example, by viewing presence information associated with the contacts list, the user can see where his contacts are on the webpage associated with the third party website (as well as other webpages). If desirable, the user can access a webpage being viewed by one or more of his contacts. Moreover, the user can begin interacting with his contacts on the webpage through blogging or instant messaging. In a similar manner, contacts can join the user by looking at presence information associated with the user on their contacts lists. In this way, the user and his contacts can freely navigate about multiple webpages socializing with each other along the way.

At block 508, one or more locations of interest may be presented to the user. Locations of interest can include webpages which have, or which currently are, experiencing types of activity which may be of interest to the user. For example a location of interest can include a webpage that is being visited by more of the user's contacts than any other webpage.

The one or more locations of interest can be presented to the user in a separate field on whatever webpage the user is viewing, such as in authentication control 112 and/or presentation display control 114. Alternately, or additionally, the one or more locations of interest can be indicated by special highlighting in the presence information on the user's contacts lists.

### CONCLUSION

Although embodiments of advertisement targeting and creation of ad-hoc microcommunities through user authentication have been described in language specific to structural features and/or methods, it is to be understood that the subject of the appended claims is not necessarily limited to the specific features or methods described. Rather, the specific features and methods are disclosed as exemplary implementations of advertisement targeting and creation of ad-hoc microcommunities through user authentication.

What is claimed is:

1. A method comprising:
accepting authentication information submitted by a user via a third party website;
accessing a personal account associated with the user using the authentication information; and
presenting information to the user on the third party website via a display control based on data associated with the personal account.

2. The method of claim 1, wherein allowing includes presenting an authentication control to the user on the third party website.

3. The method of claim 1, wherein accessing includes retrieving information from an email account associated with the user.

4. The method of claim 1, wherein presenting includes displaying an advertisement in the display control on the third party website, the advertisement being targeted to the user based on information associated with the personal account.

5. The method of claim 4, wherein displaying includes displaying the advertisement in an advertising display control on the third party website.

6. The method of claim 1, wherein presenting includes allowing the user to view information associated with the personal account.

7. The method of claim 6, wherein presenting includes displaying information associated with the personal account in a presentation display control on the third party website.

8. The method of claim 1, wherein presenting includes enabling the user to interact with a contacts list associated with the personal account.

9. A computer-readable medium having a set of computer-readable instructions residing thereon that, when executed, perform acts comprising:
accepting authentication information entered by a user into an authentication control on a webpage associated with a third party website;
accessing a personal account associated with the user using the authentication information; and
enabling presentation in a display control on the webpage of information targeting the user based on information associated with the personal account.

10. The computer-readable medium of claim 9 having a set of computer-readable instructions that, when executed, perform acts further comprising allowing a user to enter a username and a password associated with the personal account into an authentication control on the webpage.

11. The computer-readable medium of claim 9 having a set of computer-readable instructions that, when executed, perform acts further comprising targeting advertisements on the webpage to the user in an advertising display control based on information associated with the personal account.

12. The computer-readable medium of claim 11 having a set of computer-readable instructions that, when executed, perform acts further comprising allowing the user to invite contacts on a contact list in the personal account to visit the webpage.

13. The computer-readable medium of claim 9 having a set of computer-readable instructions that, when executed, perform acts further comprising indicating one or more locations of interest based on visit behaviors of contacts in a contacts list in the personal account.

14. An apparatus comprising:
an authentication module configured to access authentication information submitted by a user into an authentication control on a webpage associated with a third party website; and
a presentation module configured to:
access a personal account associated with the authentication information; and
target the user by transmitting information to the webpage, the information being based on data associated with the personal account.

15. The apparatus of claim 14, wherein the authentication module is further configured to present one or more fields in the authentication control on the webpage, the one or more fields being configured to allow the user to enter the authorization information.

16. The apparatus of claim 14, wherein the presentation module is further configured to transmit information regarding one or more interactions between the user and the webpage to an entity associated with the personal account.

17. The apparatus of claim 14, wherein the information transmitted by the presentation module comprises a contacts list associated with the personal account.

18. The apparatus of claim 14, wherein the information transmitted by the presentation module comprises one or more advertisements targeted to the user based on at least some of the data associated with the personal account.

19. The apparatus of claim 14, wherein the information transmitted by the presentation module comprises one or more locations of interest based on webpage viewing behaviors of contacts associated with the personal account.

20. The apparatus of claim 19, wherein the one or more locations of interest include a most lively location that is currently being visited by more contacts associated with the personal account than any other webpage.
